(19) United States
(12) Patent Application Publication
(10) Pub. No.: US 2005/0215455 A1
(43) Pub. Date: Sep. 29, 2005

(54) Surfactants in powdered form that can be used in tablets or gelatin capsules; preparation process and compositions containing them

(76) Inventors: Gerard Trouve, Castres (FR); Jerome Aucouturier, Chatenay-Malabry (FR); Guenole Le Calvez, Kremlin Bicetre (FR)

Correspondence Address: Linda K. Russell, Suite 1800, 2700 Post Oak Blvd., Houston, TX, 77056, US

(21) Appl. No.: 11/091,192

(22) Filed: Mar. 28, 2005

(30) Foreign Application Priority Data
Mar. 29, 2004 (FR) 0450614

(51) Int. Cl. C11D 17/00

(52) U.S. Cl. 510/421

(57) ABSTRACT

A pulverulent surfactant composition and its method of use. The composition is contains a surfactant that is liquid or pasty at ambient temperature and a solid support. The composition will flow freely, such that its flow time for 100 grams of composition is less than or equal to ten seconds. The composition may be used as a solubilizing agent in tablets, gelatin capsules, chewing gums and confectionary products.

The invention relates to novel powdered surfactants, to the process for preparing them and to their use in the preparation of tablets or gelatin capsules.

The pharmaceutical active principles developed today are often complex molecules that are relatively insoluble in water, even in an acid medium. When they are administered orally, whether tablets or gelatin capsules are mainly involved, these active principles dissolve with difficulty in the gastric or intestinal medium, which affects their bioavailability, the plasma concentrations required for the desired therapeutic effect are not then always reached, and the effectiveness of the medicinal product is therefore reduced as a result.

In order to improve the solubility and therefore the bioavailability of relatively insoluble active principles, they are sometimes formulated with surfactants that are compatible with pharmaceutical use or use in foods. Throughout the text that follows, the term “surfactant” will refer to any product or composition of products capable, within an appropriate concentration range, of decreasing the surface tension of an aqueous solution to a value of less than 50 mN/m, at ambient temperature. This surface tension can be measured by means of the Wilhemy plate method. Among these surfactants, some have a solubilizing role which makes it possible to dissolve a significant fraction of the active principle in biological fluids. They are to be found among the anionic surfactants, for instance sodium lauryl sulphate or taurocholic acid, or else among the nonionic surfactants characterized by an HLB (Hydrophilic Lipophilic Balance) number of greater than 12, often greater than or equal to 15, the HLB number being calculated as the ratio of the mass of the hydrophilic portion of the surfactant to the molar mass of the surfactant divided by 5. Examples of such a use of these surfactants are described in: “Surfactant systems, chapter 7, D. Attwood, A. T. Florence, Chapman & Hall publishers”. This reference book also teaches that solubilizing surfactants act by forming more or less spherical aggregates, called micelles, inside which are the molecules of active principles.

However, such micelles only form when the concentration of surfactant in solution reaches a minimum value. It is therefore necessary to incorporate considerable amounts of surfactant into the drug dose administered to the patient, in order for its active principle-solubilizing effect to be effectively expressed in the gastric and intestinal media. In chapter 5 of this same abovementioned reference book, the values presented in the tables demonstrate that the amounts of surfactants to be used vary according to the active principles to be solubilized; the molar ratios of the solubilizing agent to the active principle that are disclosed therein are between 0.25 and 1000. In practice, the weight ratios of the solubilizing surfactant to the active principle range from 0.5 to 20, preferably from 1 to 10.

In solid pharmaceutical forms such as gelatin capsules and especially tablets, the required amount of solubilizing surfactant to be incorporated in order to improve the solubility and the bioavailability of the active principle must not, however, impair the pharmaceutical and mechanical properties of the final formulation, which are mainly the hardness, the disaggregation rate, the flow rate or the stability.

Modern techniques for producing gelatin capsules or tablets, and in particular the technique known as “direct compression” require the provision of excipients in the form of finely divided solids capable of forming, with the active principles, a mixture of powders with well-defined physical and mechanical properties. In particular, this mixture should flow freely, i.e. the flow time for 100 g of such a mixture, measured according to the 2-9-16 test of the European pharmacopoeia, should be less than 10 s. This mixture should also be compactable, which property can be evaluated from the measurement of the tapping capacity described in test 2-9-15 of the European pharmacopoeia: the difference in apparent volumes of the mixture after 10 and 500 taps in a standardized device should thus preferably be less than 20 ml. The tablets obtained should have acceptable mechanical characteristics, i.e. should have a breaking strength (also called hardness) of preferably greater than 30 N, measured according to protocol 2-9-8 of the European pharmacopoeia, and a friability, measured according to protocol 2-9-7 of the European pharmacopoeia, of preferably less than 0.5%.

Now, most of the available surfactants that can be used for pharmaceutical applications do not satisfy these requirements since they are either liquid or pasty at normal temperature or they are solids with a very large particle size, such as flakes for example. The milling of such flakes in the form of fine powders is extremely difficult and expensive, since organic surfactants have melting points that are often low, of the order of 50° C. to 100° C., and melt under the effect of the heating in the mills. In addition, the milling yields in order to obtain powders of a few tens of microns to a few hundred microns are poor.

Magnesium stearate is one of the rare surfactants that is available in the form of a fine powder, and that can be directly incorporated into a tablet. However, this product is essentially used as a lubricant and it cannot be used at high concentrations because of its harmful effect on the hardness of the tablet.

In order to obtain solid forms, in particular tablets, containing a relatively insoluble active principle whose bioavailability must be improved, aqueous suspensions of the active principle and of the surfactant, or solutions of said active principle and surfactant in organic solvents, are today prepared and then these dispersions or solutions are sprayed onto solid supports. For example, the international publication published under the number WO 90/01329 discloses a process consisting of the preparation of an intimate mixture of a gastroresistant polymer, of a nonionic surfactant and of an active principle that is protein in nature, in an organic solvent such as methanol, ethanol, acetone or methylene chloride, and then of the evaporation of the solvent so as to obtain a powder which can optionally be incorporated into a tablet. However, the use of organic solvents limits the industrial implementation of this process.

European patent application EP 1 273 293 discloses a process for preparing micronized FENOFIBRATE with improved dissolution, which consists in preparing an aqueous suspension of this relatively insoluble active principle in the presence of a hydrophilic polymer and, optionally, of a surfactant, and then in spraying this suspension onto a water-soluble solid support in a fluidized bed. The granule obtained can be tableted or introduced into a gelatin capsule. The improvement in the solubility and in the bioavailability of the FENOFIBRATE by means of this process is therefore linked to a specific, micronized, form of the active principle and to a specific preparation process in the presence of polymer; it is not mainly linked to the surfactant, since its presence is optional. Such a process is long and expensive since it requires sophisticated equipment such as fluidized beds or atomizers. The inventors have therefore sought to develop a simple method which does not have the drawbacks disclosed above, for preparing ingestible solid compositions for pharmaceutical, dietetic, dietary or cosmetic use, in the form of tablets, of gelatin capsules, of chewing gums, of granules or of any other solid form, having suitable mechanical properties, by simple mixing of at least one relatively water-insoluble active principle and of a solubilizing surfactant for improving the bioavailability of the active principle, followed by a compression step without the addition of solvent.

It has been found that the problem posed can be solved by preparing surfactant compositions characterized in that they comprise at least one surfactant that is liquid or pasty at ambient temperature, and a solid support of apparent density after tapping (European pharmacopoeia 2-9-15) of less than 0.5, onto which the surfactant(s) is (are) adsorbed. By judiciously selecting the support, it is possible to form surfactant compositions containing from 1% to 90% of a surfactant that is liquid or pasty at ambient temperature, and from 99% to 10% of a solid. The surfactant obtained is in the form of a powder or of a granule that is a few tens to a few hundred microns in diameter, that has good flow and a good direct compression capacity or wet granulation capacity, and that is capable of releasing said surfactant in the presence of a biological medium such as gastric fluid or intestinal fluid. Once thus released in the vicinity of the active principle, the surfactant can play the role of active principle-solubilizing agent.

This is why, according to a first aspect, a subject of the invention is a pulverulent surfactant composition (Cₛ), characterized in that it consists essentially of a mixture of 1% to 90% by weight of a surfactant (SA) that is liquid or pasty at ambient temperature, and of 10% to 99% by weight of a solid support, and in that it flows freely, the flow time, measured by method 2.9.16. of the European pharmacopoeia, 4th edition, by means of a standardized flow funnel described in FIG. 2-9-16-2 of the European pharmacopoeia, of 100 g of said composition Cₛ being less than or equal to 10 s.

Surfactants that are liquid or pasty at ambient temperature, i.e. at a temperature of between approximately 10° C. and approximately 35° C. include in particular, but without implied limitation, sorbitan esters, ethoxylated sorbitan esters, ethers of sugars, such as ethers of lactose, of sucrose, of xylose, of mannitol or of xylitol, ethoxylated fatty alcohols, fatty acids and their salts, ethoxylated fatty acids, polyglyceryl esters, copolymers of propylene oxide and of ethylene oxide, phospholipids or lecithins, amino acid fatty chain acylates, triglycerides of plant or synthetic origin and their ethoxylated derivatives, acetylated monoglycerides, sodium lauryl sulphate and its derivatives, or alternatively taurocholic acid and its derivatives.

Among the abovementioned surfactants, there are more particularly:
the eicosaethoxylated sorbitan monooleate (EO index=20; HLB=15; liquid at ambient temperature) sold, for example, under the trade mark Montanox™ 80;
the eicosaethoxylated sorbitan trioleate (EO index=20; HLB=12; liquid at ambient temperature) sold, for example, under the trade mark Montanox™ 85;
the eicosaethoxylated sorbitan monolaurate (EO index=20; HLB=15; liquid at ambient temperature) sold, for example, under the trade mark Montanox™ 20;
tricosaethoxylated lauryl alcohol (EO index=23; HLB=16.9; wax at ambient temperature) sold, for example, under the trade mark Simulsol™ P23;
the pentacosaethoxylated hydrogenated castor oil (EO index=25; HLB=12; viscous liquid at ambient temperature) sold, for example, under the trade mark Simulsol™ 1292;
the tetracontaethoxylated hydrogenated castor oil (EO index=40; HLB=14; pasty liquid at ambient temperature) sold, for example, under the trade mark Simulsol™ 4000 or Simulsol™ 1293;
the hexacontaethoxylated castor oil (EO index=60; HLB=14; pasty liquid at ambient temperature) sold, for example, under the trade mark Simulsol™ 1285;
the decaethoxylated oleic acid (EO index=10; HLB=13; liquid at ambient temperature) sold, for example, under the trade mark Simulsol™ 2599.

Use may also be made of mixtures of all these surfactants with one another or with a more lipophilic surfactant such as the sorbitan monooleate (HLB=4.3) sold under the trade mark Montane™ 80.

In the surfactant composition Cₛ as defined above, the solid support generally has an apparent density after tapping of less than 0.5. The term “apparent density” denotes the ratio M/V in which M represents the mass of the material and V its apparent volume. The apparent density μ is determined according to experimental protocol 2-9-15 of the European pharmacopoeia. Examples of such a solid support include those in the form of fine powders or granules of a few tens to a few hundred microns, soluble or insoluble in an aqueous medium, and which have a large specific surface area. Mention may be made, for example, of microcrystalline celluloses; sugars such as lactose, sorbitol, mannitol, xylitol or maltitol; mineral salts such as calcium carbonate, calcium phosphate, calcium gluconate, magnesium gluconate or manganese gluconate, aluminosilicates, or fumed or precipitated silicas.

Among these products, preference is given to those which are compressible and have a very large specific surface area, for instance the calcium phosphates sold under the trade mark Fujicalin™ or the aluminosilicates sold under the trade mark Neusilin™.

According to another preferred characteristic, the composition (Cₛ) as defined above has a tapping capacity of less than. 20 ml in test 2-9-15 of the European pharmacopoeia.

According to a final preferred characteristic, the composition (Cₛ) as defined above has particle sizes of less than 1000 μm, preferably of between approximately 5 μm and approximately 500 μm, even more preferably of between approximately 10 and approximately 250 μm, measured using a laser particle sizer or a series of sieves standardized according to the prescriptions of the European pharmacopoeia 2-1-4.

According to a second aspect, a subject of the invention is a process for preparing the surfactant composition (Cₛ) as defined above, characterized in that from 1% to 80% by weight of a surfactant that is liquid or pasty at ambient temperature is adsorbed onto from 20% to 99% by weight of a solid support.

The adsorption can take place by mixing in a mechanical homogenizer such as, for example, a mixer of the Diosna™ or Lodige™ brand. This process is preferred if the solid support is water-insoluble, for instance calcium phosphate. In this case, the liquid surfactant is poured, with stirring, into the mixer preloaded with the solid support, until a product with a dry and homogeneous appearance is obtained. It can also take place by means of an adsorption-granulation process. This is advantageously used in the case of soluble solid supports such as lactose. The liquid surfactant is then poured onto the lactose until a dry and homogeneous mixture is obtained, and then approximately 2% of water is added to this mixture so as to obtain a granulated material with a mean diameter of approximately 200 to 500 μm.

It can also take place by spraying the liquid surfactant (pure or in solution) onto the solid support in a fluidized bed, in which a stream of hot air causes the solid support to move and optionally eliminates the solvent in which the surfactant is dissolved. This solvent is preferably water.

In these various processes, it is possible to heat the surfactant or the solution of surfactant that it is desired to adsorb onto the solid support, in order to decrease the viscosity of the liquids and to facilitate the distribution thereof over the solid support. The proportions of surfactants that can be adsorbed onto the supports depend on the nature of the support and on its specific surface area. They can range from approximately 1 to approximately 95%, most commonly from 1 to 80% by weight, of the final product obtained.

In order to further improve the bioavailability of the active agent, cosolvents or hydrotropes, for instance glycerol, glycols, mineral or plant oils, light alcohols, etc., can be adsorbed together with the surfactants onto the solid support.

According to a third aspect, a subject of the invention is an edible composition (C), characterized in that it comprises:
(a)—a non-zero amount of at least one active principle (AP),
(b)—a non-zero amount and up to 80% of at least one surfactant composition (Cₛ) as defined above, and such that the (Cₛ)/(AP) weight ratio is greater than or equal to 0.25 and less than or equal to 20, and preferably greater than or equal to 1 and less than or equal to 10, and, optionally,
(c)—up to 95% by weight of one or more edible excipients,
it being understood that the sum of the percentages by weight of the components (a) (b) and (c) is equal to 100%.

The term “edible excipient” denotes the excipients usually used in the preparation of pharmaceutical forms intended for oral administration. For the tablets, this is intended to mean both the excipients of the core of the formulation and the excipients for coating said core. Mention is made more particularly of diluents such as lactose, starches, microcrystalline celluloses, calcium phosphate or calcium carbonate, binders such as polyvinyl alcohols, povidone, cellulose derivatives, pregelatinized starches, lubricants such as magnesium stearate, stearic acid, hydrogenated plant oils, synthetic triglycerides, talc, flow agents such as silicas, disintegrating agents such as carboxymethyl-celluloses, crosslinked povidones, wetting agents such as polysorbates, sodium lauryl sulphate, lecithins, film-forming polymers such as acrylic polymers, cellulosic polymers, polyvinyl alcohols, plasticizers such as glycerol, polyethylene glycols, propylene glycol, acetylated monoglycerides, triacetin, phthalates, or colouring agents in the form of lakes or of pigments such as iron oxide or titanium oxide.

The term “edible” is intended to mean any ingestible composition, whether this involves medicinal products, products intended for cosmetic application or food supplements. It may also involve confectionery products or plant extracts.

According to a particular characteristic, the composition (C) as defined above contains up to 20% by weight of active principle (AP).

According to a particular characteristic, the composition (C) as defined above contains up to 80% by weight of the surfactant composition (Cₛ) as defined above.

According to another preferred characteristic, the composition (C) as defined above is in the form of a pulverulent solid that flows freely, the flow time for 100 g of surfactant being less than 10 s in test 2-9-16 of the European pharmacopoeia.

According to another preferred characteristic, the composition (C) as defined above has a tapping capacity of less than 20 ml in test 2-9-15 of the European pharmacopoeia.

According to a final preferred characteristic, the composition (C) as defined above has particle sizes of less than 1000 μm, preferably of between approximately 5 μm and approximately 500 μm, even more preferably of between approximately 10 and approximately 250 μm, measured using a laser particle sizer or a series of sieves standardized according to the prescriptions of the European pharmacopoeia 2-1-4.

The composition (C) as defined above can be used more particularly in the form of tablets, of gelatin capsules, of chewing gums or of granules.

According to a fourth aspect, a subject of the invention is the use of the surfactant composition (Cₛ) as an agent for solubilizing an active principle (AP).

According to a final aspect, a subject of the invention is the use of the surfactant composition (Cₛ) as defined above as a solubilizing agent in tablets, gelatin capsules, chewing gums or confectionery products.

The following examples illustrate the invention without, however, limiting it.

Preparation of Surfactant Compositions According to the Invention

### EXAMPLE 1

Surfactants are prepared in the form of powders by adsorption of various liquid surfactants onto a porous solid support, the calcium phosphate Fujicalin™ SG sold by Fuji, Japan. The various surfactants used successively are:

Montonox™ 80, Simulsol™ P23, Simulsol™ 1292, Simulsol™ 4000, the mixture Montane™ 80/Montanox™ 80, in an 84/16 proportion by weight, and the mixture Montane™ 80/Montanox™ 80 in a 65/35 proportion by weight.

400 g of solid support are introduced into the container of a Diosna™ V10 mixer. 270 g of surfactant, heated beforehand in a hot room if necessary, are weighed and then introduced, continuously by means of a funnel, onto the powder and with stirring at 205 rpm.

The characteristics of the surfactants, in the form of powder, obtained are determined according to protocol 2-9-16 of the European pharmacopoeia for the flow time and protocol 2-9-15 (apparent volume) for the tapping capacity.

Determination of the Flow Time

100 g of powder are introduced, without tapping, into a standardized funnel described in FIG. 2-9-16-2 of the European pharmacopoeia, the orifice of which has been closed beforehand. The orifice is freed and the flow time of the entire sample is measured. Three determinations are made.

The result consisting either of the mean of the three measurements, on condition that none of the individual values differs by more than 10% from the mean value, or of the mean of the two extreme values, if the individual values differ by more than 10% of the mean value, represents the flow capacity of the powder.

Determination of the Apparent Volume

100 g of the powder obtained is poured into a dry 250 ml measuring cylinder, with 2 ml graduations, weighing 220±40 g, and the non-tapped apparent volume V₀ is measured to within 1 ml. The measuring cylinder is fixed on the support of the Erweka™ tapping machine, said support with its fixing device having a mass of 450±5 g, and said machine being able to cause, per minute, 250±15 drops of a height of 3±0.2 mm.

The powder is subjected to 10, 500 and then 1250 drops, reading the volumes, respectively, after 10 drops (V₁₀), after 500 drops (V₅₀₀) and after 1250 drops (V₁₂₅₀). If the difference V₅₀₀-V₁₂₅₀ is greater than 2 ml, the powder is subjected to a further 1250 drops and the volume after 2500 drops (V₂₅₀₀) is measured.

These measurements make it possible to express the following results:
the apparent volume before tapping or bulk volume: V₀;
the apparent volume after tapping or tapped volume: V₁₂₅₀ (or, where appropriate: V₂₅₀₀);
the tapping capacity: V₁₀-V₅₀₀;
the apparent density before tapping or bulk product density: m/V₀;
the apparent density after tapping or tapped product density: m/V₁₂₅₀ (or, where appropriate: m/V₂₅₀₀)

It is generally accepted that powders exhibiting flow times of less than 10 seconds and tapping capacities of less than 20 ml have the free-flow and compressibility qualities required for use in the production of tablets or gelatin capsules.

The particle size of the powder obtained is obtained by determining the mean diameter thereof with a Malvern Mastersizer™ laser particle sizer.

The results are reported in the table below:

| | | Tapping | |
|---|---|---|---|
| | | capacity | Mean |
| | Flow | (V₁₀ − V₅₀₀) | diameter |
| Powdered surfactant | (s) | in ml | (μm) |
| Fujicalin ™ SG + Montanox ™ 80 | 6.0 | 10 | 215 |
| Fujicalin ™ SG + Simulsol ™ 1292 | 4.5 | 8 | 153 |
| Fujicalin ™ SG + Simulsol ™ 4000 | 4.6 | 8 | 172 |
| Fujicalin ™ SG + Simulsol ™ P23 | 3.1 | 5 | 133 |
| Fujicalin ™ SG + [Montane ™ 80 − | 4.3 | 7 | 186 |
| Montanox ™ 80 (84/16)] | | | |
| Fujicalin ™ SG + [Montane ™ 80 − | 4.5 | 8 | 179 |
| Montanox ™ 80 (65/35)] | | | |

### EXAMPLE 2

The test of Example 1 is reproduced, replacing the Fujicalin™ SG solid support with a calcium carbonate, Destab™ 90 sold by PDI—USA. In this case, 200 g of each of the initial surfactants are mixed with 800 g of the Destab™ 90 in the Diosna™ V10 mixer. The surfactants, in the form of powders, obtained have the following characteristics:

| | | Tapping | |
|---|---|---|---|
| | | capacity | Mean |
| | Flow | (V₁₀ − V₅₀₀) | diameter |
| Powdered surfactant | (s) | in ml | (μm) |
| Destab ™ SG + Montanox ™ 80 | 12.9 | 19 | 93 |
| Destab ™ SG + Simulsol ™ 1292 | 11.9 | 19 | 96 |
| Destab ™ SG + Simulsol ™ 4000 | 9.8 | 23 | 84 |
| Destab ™ SG + Simulsol ™ P23 | 4.7 | 10 | 79 |

### EXAMPLE 3

The test of Example 1 is reproduced, replacing the Fujicalin™ SG solid support with a magnesium aluminometasilicate (Neusilin™ US2 sold by Fuji, Japan). In this case, 600 g of each of the initial surfactants are mixed with 200 g of Neusilin in the Diosna™ V10 mixer. The surfactants, in the form of powders, obtained have the following characteristics:

| | | Tapping | |
|---|---|---|---|
| | | capacity | Mean |
| | Flow | (V₁₀ − V₅₀₀) | diameter |
| Powdered surfactant | (s) | in ml | (μm) |
| Neusilin ™ SG + Montanox ™ 80 | 8.2 | 7 | 95 |
| Neusilin ™ SG + Simulsol ™ 1292 | 8.6 | 7 | 100 |
| Neusilin ™ SG + Simulsol ™ 4000 | 8.5 | 9 | 103 |
| Neusilin ™ SG + Simulsol ™ P23 | 8.2 | 8 | 87 |
| Neusilin ™ SG + [Montane ™ 80 − | 9.8 | 8 | 90 |
| Montanox ™ 80 (84/16)] | | | |
| Neusilin ™ SG + [Montane ™ 80 − | 7.3 | 10 | 88 |
| Montanox ™ 80 (65/35)] | | | |

### EXAMPLE 4

10 kg of a magnesium aluminometasilicate (Neusilin™ US2—Fuji) are introduced into a Diosna™ V100-type mixer and 23.5 kg of polysorbate 80 (Montanox™ 80 —Seppic) are gradually poured onto this by means of a pump, while at the same time maintaining stirring at speed 1 in the mixer for 2 minutes at ambient temperature. A surfactant in the form of a powder, having the following characteristics, is obtained:

| | |
|---|---|
| Flow capacity | 7 s |
| Tapping capacity (V₁₀ − V₅₀₀) | 14 ml |
| Tapped density | 0.59 g/ml |
| Retention of 200 μm sieve | 10% |
| Mean diameter Dv50 (μm) (laser particle | 102 μm |
| sizer) | |

### EXAMPLE 5

A mixture made up of 2 liquid surfactants, a mannitan ester (20 g), an ethoxylated oleic acid (180 g), of 200 g of a liquid mineral oil and of 40 g of water is prepared. 1200 g of Fast Flo™ lactose and 400 g of calcium gluconate are loaded into a Diosna mixer, and then the liquid surfactant mixture is poured in with stirring and adsorbed onto the powders. After transfer to an oven at 50° C., a dry grain with a mean diameter of 500 μm, which flows in 8 seconds according to the test of the European pharmacopoeia, is obtained. This grain dissolves in 3.5 min in a physiological saline, releasing 90% of the adsorbed surfactants. This adsorbed dry surfactant is then mixed with a relatively insoluble active agent. The mixture obtained can be introduced into gelatin capsules so as to form a medicinal product with improved bioavailability.

Surfactant Compositions+Active Principle According to the Invention

### EXAMPLE 6

Procetofen or isopropyl 2-[4-(4-chloro-benzoyl)phenoxy]-2-methylpropionate, sold under the name Fenofibrate™ is an active principle that inhibits the hepatic synthesis of cholesterol and plasma glycerides. It is virtually completely water-insoluble (solubility<3 mg/l). Fenofibrate™ dissolution kinetics are studied using an Erweka DT600 Dissolutest™ device, set at 37° C.±0.5° C., with a paddle rotation of 200 rpm. The dissolving medium consists of 500 ml of a buffer medium with a pH of 1.7, prepared in accordance with the European pharmacopoeia. Samples are taken regularly, and are then subsequently filtered by means of a syringe filter and the amount of Fenofibrate™ in these samples is determined by High Performance Liquid Chromatography (HPLC), equipped with a 286 nm UV-detector.

In a preliminary experiment, the ability of Simulsol™ 4000 to solubilize Fenofibrate™ is demonstrated. For this, 1500 mg of Fenofibrate™ and 1000 mg of Simulsol™ 4000 are introduced into the buffer and the amounts of active principle solubilized over time are measured. The amount of Fenofibrate™, expressed as % of the total Fenofibrate™ introduced, increases rapidly up to a plateau value of approximately 1%. The kinetics of dissolution of Fenofibrate™ contained in Lipanthyl™ 200 gelatin capsules, a medicinal product sold on the French market, are then studied. The protocol used is that recommended in chapter 2-9-3 of the European pharmacopoeia; the same Erweka™ Dissolutest device is used, under the same conditions are above. Samples are taken after 5, 10, 20 and 30 minutes, and are filtered and then analysed by HPLC equipped with a 286 nm UV-detector. The results below confirm the very low solubility of the Fenofibrate™. After stirring for 30 min, the surfactant in powdered form produced from Neusilin™ and Simulsol™ 4000, the preparation of which is described in Example 3, is introduced. The mass of powdered surfactant introduced is equal to the mass of Fenofibrate™ contained in the gelatin capsule. Consequently, the Simulsol™ 400/Fenofibrate™ ratio is the same as that involved in the preliminary experiment. Further samples are taken 5, 10 and 20 minutes after introduction of the surfactant in powdered form. The amount of Fenofibrate™ rapidly increases up to the same plateau value of 1% as in the preliminary experiment. The solubilizing effect of the surfactant in powdered form is thus demonstrated; it is equivalent to that of the initial form of the surfactant.

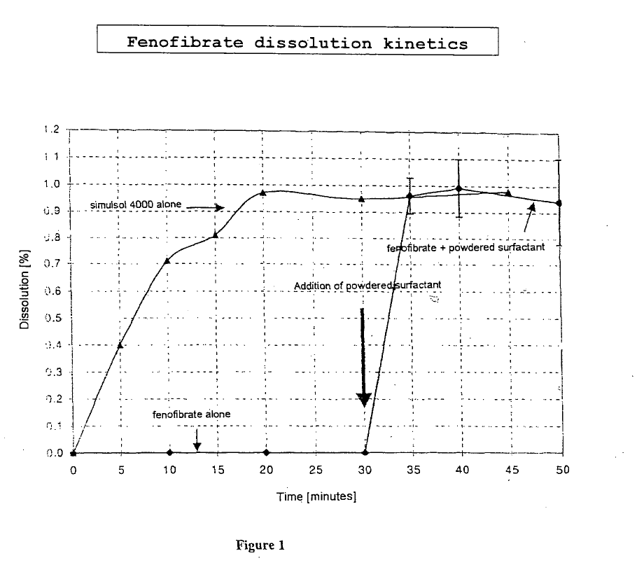

FIG. 1 is a graph demonstrating the results of the present study.

### EXAMPLE 7

The dissolution of Fenofibrate™ contained in tablets is now studied. Besides the active principle, the tablets contain. lactose and microcrystalline cellulose as diluents and binders, respectively, magnesium stearate as a lubricant and the surfactant in powdered form produced from Neusilin™ and from Simulsol™ 4000, the preparation of which is described in Example 3, as agent for solubilizing the Fenofibrate™. Three series of tablets, with different powdered surfactant [Cₛ]/Fenofibrate [AP] ratios, and also a control formula, are prepared. To produce the tablets, all the powders are first of all mixed in a Turbula™ mixer and are then compressed by means of a Frogerais™ MR6 rotary press, equipped with 6 punches 11 cm in diameter. The composition and the characteristics of the tablets obtained are given in the table below. They are all of acceptable friability and hardness.

Determination of the Friability of the Tablets

A sample of 20 tablets is placed on a sieve No. 1000 (1000 μm) and the free dust is eliminated by means of compressed air. The tablets are then weighed and are then placed in an Erweka™ rotary drum with an inside diameter of 290 mm, consisting of a transparent synthetic polymer with polished inside surfaces that do not produce any static electricity, mounted on an entrainment system whose rotation rate is 25±1 rpm. 100 rotations are effected, the tablets are taken out of the drum, the free dust is removed therefrom with compressed air, and they are weighed to within one mg. If the loss in mass is greater than 1%, the operation is repeated two more times and the. result is the mean of the three results. The friability is expressed in terms of loss of mass and calculated as a percentage of the initial mass.

Determination of the Hardness of the Tablets

The hardness of the tablets is determined by means of a two-jawed device for measuring the breaking strength of the tablet by crushing between the two jaws. The measurement is carried out on 10 tablets. The result is the mean value of the forces measured in Newtons.

| | | [Cₛ]/[AP] ratio | | | |
|---|---|---|---|---|---|
| Components | Control | ½ | 1 | 2 | 10 |
| Fenofibrate ™ | 15.00% | 15.00% | 15.00% | 7.50% | 1.50% |
| Powdered surfactant | 0.00% | 7.50% | 15.00% | 15.00% | 15.00% |
| Neusilin ™ | 15.00% | 0.00% | 0.00% | 0.00% | 0.00% |
| Fast Flo ™ lactose | 52.125% | 57.75% | 52.125% | 57.75% | 62.25% |
| Vivapur ™ PH 102 | 17.375% | 19.25% | 17.375% | 19.25% | 20.75% |
| Magnesium stearate | 0.50% | 0.50% | 0.50% | 0.50% | 0.50% |
| Weight (mg) | 547 | 537 | 558 | 563 | 544 |
| Friability (%) | 0.4% | 0.43% | 0 | 0.02% | 0.4% |
| Hardness (N) | 32 | 48 | 66 | 61 | 36 |

The dissolution kinetics of the tablets prepared above are determined in accordance with protocol 2-9-3 of the European pharmacopoeia.

An Erweka™ Dissolutest™ device set at 37° C.±0.5° C. with a blade rotation of 200 rpm is used. The dissolving media are buffer media with a pH of 1.7 and 7.2, prepared in accordance with the European pharmacopoeia, having a volume of 500 ml. Samples were taken after 5, 10, 15, 20, 30 and 45 minutes. These samples are subsequently filtered by means of a syringe filter and then analysed by HPLC equipped with a 286 nm UV-detector. The results of the assays are expressed as percentages of the amount of Fenofibrate introduced. The tables below show the change in this percentage over time. It demonstrates a very significant increase in the percentage of Fenofibrate dissolved compared with the control test when the amount of surfactant according to the invention in the tablets is increased, whatever the pH.

[Cₛ]/[AP] ratio

| | Control | ½ | 1 | 2 | 10 |
|---|---|---|---|---|---|
| 5 min | — | 0.15 | 0.15 | 3.69 | 11.9 |
| 10 min | 0.015 | 0.20 | 0.53 | 3.43 | 12.8 |
| 15 min | — | 0.23 | 0.82 | 3.09 | 12.7 |
| 20 min | 0.015 | 0.18 | 1.33 | 2.81 | 11.5 |
| 30 min | 0.015 | 0.18 | 1.46 | 2.44 | 12.8 |
| 45 min | 0.015 | 0.20 | 1.55 | 2.33 | 12.6 |

% of the maximum amount of Fenofibrate that can be solubilized - buffer medium pH 1.7

[Cₛ]/[AP] ratio

| | Control | ½ | 1 | 2 | 10 |
|---|---|---|---|---|---|
| 5 min | — | 0.32 | 0.02 | 4.26 | 22.4 |
| 10 min | 0.015 | 0.48 | 0.13 | 4.16 | 23.7 |
| 15 min | — | 0.52 | 0.66 | 3.79 | 25.2 |
| 20 min | 0.015 | 0.50 | 1.20 | 3.52 | 23.8 |
| 30 min | 0.015 | 0.50 | 1.39 | 3.22 | 23.0 |
| 45 min | 0.015 | 0.48 | 1.45 | 2.96 | 20.9 |

% of the maximum amount of Fenofibrate that can be solubilized - buffer medium pH 7.2

### EXAMPLE 8

The experiment described in Example 7 is reproduced, but using the surfactant in powdered form consisting of Neusilin™ and of Montanox 80™, the production of which is described in Example 4. The composition of the tablets prepared and their characteristics are given below:

| | Tablet 8-1 | Tablet 8-2 |
|---|---|---|
| | [Cₛ]/AP ratio 1/1 | [Cₛ]/AP ratio 10/1 |
| Fenofibrate: | 15 | 1.5 |
| Lactose | 51.4 | 61.5 |
| Microcrystalline | 17.1 | 20.5 |
| cellulose | | |
| Magnesium stearate | 0.5 | 0.5 |
| Stearic acid | 1.0 | 1.0 |
| Powdered surfactant of | 15 | 15 |
| Example 4 | | |
| Average weight (mg) | 542 | 533 |
| Hardness (N) | 38 | 45 |
| Friability (%) | 0.06 | 0.1 |

Their dissolution is studied in two buffer media at pH. 1.7 and 7.2, respectively, using the protocol described in Example 7. The results obtained appear in the table below and show that the surfactant in powdered form allows a dissolution that is clearly improved compared with a control tablet without powdered surfactant.

| | Control | [Cₛ]/[AP] = 1 | [Cₛ]/[AP] = 10 |
|---|---|---|---|
| 5 min | — | 0 | 13.4 |
| 10 min | 0.015 | 0.06 | 32.8 |
| 15 min | — | 0.15 | 47.5 |
| 20 min | 0.015 | 0.39 | 46.7 |
| 30 min | 0.015 | 0.66 | 41.5 |
| 45 min | 0.015 | 0.70 | 22.8 |

% of the maximum amount of Fenofibrate that can be solubilized - buffer medium pH 1.7

| | Control | [Cₛ]/[AP] = 1 | [Cₛ]/[AP] = 10 |
|---|---|---|---|
| 5 min | — | 0.05 | 11.6 |
| 10 min | 0.015 | 0.06 | 27.0 |
| 15 min | — | 0.29 | 31.7 |
| 20 min | 0.015 | 0.53 | 46.4 |
| 30 min | 0.015 | 0.70 | 12.1 |
| 45 min | 0.015 | 0.76 | 11.8 |

% of the maximum amount of Fenofibrate that can be solubilized - buffer medium pH 7.2

### EXAMPLE 9

### Theophylline Tablets

Theophylline is a relatively water-insoluble anti-histamine (maximum solubility 8 mg/l). The production of a theophylline tablet with improved bioavailability is sought. For this, the mixtures of powders described in the table below are prepared using either the surfactant made up of Fujicalin™ and of Montanox™ 80, the preparation of which is described in Example 1, or the surfactant made up of Neusilin™ and of Montanox™ 80, the preparation of which is described in Example 4. The tablets are prepared as above on a Frogerais™ MR6 machine. Their characteristics are given in the table below:

| | Tablet 9-1 | Tablet 9-2 | Reference |
|---|---|---|---|
| Anhydrous theophylline | 10 | 10 | 10 |
| Fast Flo ™ lactose | 25.8 | 29 | 29 |
| Microcrystalline | 38.7 | 43.5 | 43.5 |
| cellulose | | | |
| Fujicalin ™-Montanox ™ 80 | 25 | 0 | 0 |
| Neusilin ™-Montanox ™ 80 | 0 | 17 | 0 |
| Magnesium stearate | 0.5 | 0.5 | 0.5 |
| Neusilin ™ | 0 | 0 | 17 |
| Average weight (mg) | 451 | 445 | 450 |
| Hardness (N) | 40 | 61 | 58 |
| Friability (%) | 0.06 | 0.03 | 0.08 |

The dissolution tests are carried out in an acetate buffer medium at pH=4.6, corresponding to the pH of the duodenum in the gastrointestinal tract, prepared in accordance with the European pharmacopoeia 4.02. The results, expressed as % of the total amount of theo-phylline, show that the powdered surfactants incorporated into the tablets make it possible to solubilize a larger amount of theophylline, with kinetics which depend on the nature of the powdered surfactant.

| | Tablet 9-1 | Tablet 9-2 | Reference |
|---|---|---|---|
| 5 min | 10 | 10 | 32 |
| 10 min | 42 | 21 | 42 |
| 20 min | 66 | 59 | 55 |
| 30 min | 70 | 75 | 62 |
| 40 min | 73 | 84 | 65 |
| 50 min | 73 | 89 | 69 |
| 60 min | 75 | 91 | 70 |

Theophylline dissolution kinetics in medium at pH 4.6

1-15. (canceled)

16. A pulverulent surfactant composition, wherein:
a) said composition comprises a pulverulent surfactant composition consisting essentially of:
1) about 1% to about 90%, by weight, of a surfactant, wherein said surfactant is of a first form at ambient temperature, wherein said first form comprises at least one member selected from the group consisting of:
aa) a liquid form; and
bb) a paste-like form; and
2) about 10% to about 99%, by weight, of a solid support; and
b) said composition has a flow time of less than or equal to 10 seconds for 100 grams.

17. The composition of claim 16, wherein said surfactant comprises at least one member selected from the group consisting of:
a) sorbitan esters;
b) ethoxylated sorbitan esters;
c) ethers of sugars;
d) ethoxylated fatty alcohols;
e) fatty acids and their salts;
f) ethoxylated fatty acids;
g) polyglyceryl esters;
i) copolymers of propylene oxide;
j) copolymers of ethylene oxide;
k) phospholipids;
l) lecithins;
m) amino acid fatty chain acylates;
n) triglycerides of plant or synthetic origin and their ethoxylated derivatives;
o) acetylated monoglycerides;
p) sodium lauryl sulphate and its derivatives; and
q) taurocholic acid and its derivatives.

18. The composition of claim 17, wherein said ethers of sugars comprise at least one member selected from the group consisting of:
a) ethers of lactose;
b) ethers of sucrose;
c) ethers of xylose;
d) ethers of mannitol; and
e) ethers of xylitol.

19. The composition of claim 17, wherein said surfactant comprises at least one member selected from the group consisting of:
a) eicosaethoxylated sorbitan monooleate;
b) eicosaethoxylated sorbitan trioleate;
c) eicosaethoxylated sorbitan monolaurate;
d) pentacosaethoxylated hydrogenated castor oil;
e) tetracontaethoxylated hydrogenated castor oil;
f) hexacontaethoxylated castor oil; and
g) decaethoxylated oleic acid.

20. The composition of claim 19, further comprising a mixture of said surfactant and sorbitan monooleate.

21. The composition of claim 16, wherein said solid support has an apparent density, after tapping, of less than about 0.5.

22. The composition of claim 21, wherein said solid support comprises at least one member selected from the group consisting of:
a) microcrystalline celluloses;
b) lactose, sorbitol;
c) mannitol;
d) xylitol;
e) maltitol;
f) calcium carbonate;
g) calcium phosphate;
h) calcium gluconate;
i) magnesium gluconate;
j) manganese gluconate;
k) aluminosilicates;
l) fumed silicas; and
m) precipitated silicas.

23. The composition of claim 22, wherein said solid support comprises at least one member selected from the group consisting of:
a) calcium phosphate; and
b) aluminosilicates.

24. The composition of claim 16, wherein said composition has a tapping capacity of less than about 20 ml.

25. The composition of claim 16, wherein the particle size of said composition is less than about 1000 μm.

26. The composition of claim 25, wherein said particle size is between about 5 μm and about 500 μm.

27. The composition of claim 26, wherein said particle size is between about 10 μm and about 250 μm.

28. A method which may be used for preparing a surfactant composition, wherein:
a) the composition prepared comprises a pulverulent surfactant composition, wherein:
1) said composition comprises a pulverulent surfactant composition consisting essentially of:
aa) about 1% to about 90%, by weight, of a surfactant, wherein said surfactant is of a first form at ambient temperature, wherein said first form comprises at least one member selected from the group consisting of:
i) a liquid form; and
ii) a paste-like form; and
bb) about 10% to about 99%, by weight, of a solid support; and
2) said composition has a flow time of less than or equal to 10 seconds for 100 grams; and
b) said method comprises adsorbing said surfactant into said solid support.

29. A composition which may be used as an edible composition, said edible composition comprising:
a) at least one active principle;
b) less than about 80%, by weight, of at least one pulverulent surfactant composition, wherein:
1) said pulverulent surfactant composition consists essentially of:
aa) about 1% to about 90%, by weight, of a surfactant, wherein said surfactant is of a first form at ambient temperature, wherein said first form comprises at least one member selected from the group consisting of:
i) a liquid form; and
ii) a paste-like form; and
bb) about 10% to about 99%, by weight, of a solid support; and
2) said pulverulent surfactant composition has a flow time of less than or equal to 10 seconds for 100 grams; and
c) the weight ratio of said surfactant composition to said active principle is in the range between about 0.25 and about 20.

30. The composition of claim 29, wherein said weight ratio is between about 1 and about 10.

31. The composition of claim 29, further comprising less than about 95%, by weight, of at least one edible excipient.

32. The composition of claim 29, wherein said composition comprises less than about 20%, by weight, of said active principle.

33. The composition of claim 29, wherein said composition comprises less than about 80%, by weight, of said pulverulent surfactant composition.

34. The composition of claim 29, wherein:
a) said edible composition is a free-flowing pulverulent solid; and
b) the flow time for about 100 grams of said edible composition is less than about 10 seconds.

35. A method which may be used to solubilize an active principle, said method comprising solublizing an active principle with a pulverulent surfactant composition, wherein:
a) said composition comprises a pulverulent surfactant composition consisting essentially of:
1) about 1% to about 90%, by weight, of a surfactant, wherein said surfactant is of a first form at ambient temperature, wherein said first form comprises at least one member selected from the group consisting of:
aa) a liquid form; and
bb) a paste-like form; and
2) about 10% to about 99%, by weight, of a solid support; and
b) said composition has a flow time of less than or equal to 10 seconds for 100 grams.

36. A method which may be used for solublizing products, said method comprising solubilizing products by including in said products a solublizing agent, wherein:
a) said solublizing agent comprises a pulverulent surfactant composition, wherein:
1) said composition comprises a pulverulent surfactant composition consisting essentially of:
aa) about 1% to about 90%, by weight, of a surfactant, wherein said surfactant is of a first form at ambient temperature, wherein said first form comprises at least one member selected from the group consisting of:
i) a liquid form; and
ii) a paste-like form; and
bb) about 10% to about 99%, by weight, of a solid support; and
2) said composition has a flow time of less than or equal to 10 seconds for 100 grams; and
b) said products comprise:
1) tablets;
2) gelatin capsules;
3) chewing gums; and
4) confectionary products.
